(19) United States
(12) Patent Application Publication
(10) Pub. No.: US 2005/0162121 A1
(43) Pub. Date: Jul. 28, 2005

(54) Multifunctional and portable solar charger

(75) Inventor: King Kwong Chan, Hong Kong (CN)

Correspondence Address: SUGHRUE MION, PLLC, 2100 PENNSYLVANIA AVENUE, N.W., SUITE 800, WASHINGTON, DC, 20037, US

(73) Assignee: King Kwong Chan, Hong Kong (CN)

(21) Appl. No.: 10/992,679

(22) Filed: Nov. 22, 2004

(30) Foreign Application Priority Data
Jan. 28, 2004 (HK) 04100557.1

(51) Int. Cl. H02J 7/35

(52) U.S. Cl. 320/101

(57) ABSTRACT

The present invention relates to a multifunctional and portable solar charger, more particularly, to a portable solar charger which combines the functions of charging, illumination and power supply together in order to perform effectively transform between a low voltage and a high voltage and conversion between chemical energy and electrical energy, when a storage battery of the charger is charged with the electrical energy, the electrical energy can be transferred to a mobile phone or its battery and other mini-type electrical apparatus such as digital camera, portable computer and portable CD player, in addition, the charger can be connected to an alternating current (AC) power supply.

### TECHNCIAL FIELD OF THE INVETION

The present invention relates to a multifunctional and portable solar charger, more particularly, to a portable solar charger combining functions of charging, power supply and illumination together in order to perform effectively transform between a low voltage and a high voltage and conversion between chemical energy and electrical energy, when a storage battery of the charger is charged with the electrical energy, the electrical energy can be transferred to a mobile phone or its battery and other mini-type electrical apparatus such as digital camera, portable computer and portable CD player, in addition, the charger can be connected to an alternating current (AC) power supply.

### BACKGROUND ART OF THE INVENTION

With developments of the technology and improvements of the people's living standard, various high-tech products such as mobile phone, digital camera and portable computer are widely used, however, chargers used for the above products are limited to connect to a AC power supply. When a person is in a place where it is inconvenient to use electrical energy or the electrical voltage is different from that used by the above high-tech products, for example, the person travels to other places for a geoscience exploration or climbs mountains for an exploratory search, the above high-tech products can not be used effectively when the electrical energy is exhausted or insufficient. Further, the conventional chargers can not be used as an independent power supply, the commonly used mini-type electrical apparatus such as portable game machine, digital cameral, CD player, walkman, repeatedly playing device and PDA processor are required to be equipped with an additional power supply such as dry batteries if a person want to use it while he is out. The dry batteries may cause environment pollution and wasting of resources. Therefore, with the development of the technology and the replacement of the older generation of products by new ones, the conventional chargers could not meet the market requirements any more. In addition, the conventional solar charger could not convert chemical energy into electrical energy and transform the high voltage into the low voltage. The solar charger of the present invention not only has the function of charging but also can be used as an independent power supply and an electric torch. Further, the solar charger can be used outdoors, the solar energy is stored in storage batteries as electrical energy, the voltage thereof is boosted, and the electrical energy is transferred to another product based on the principle of water level difference.

### SUMMARY OF THE INVENTION

Accordingly, an object of the present invention is to solve the above problems in the prior art. In order to achieve the above object, the present invention provides a multifunctional and portable solar charger which not only has a function of charging but also can be used as a power supply independently. Moreover, the storage battery is low in the rate of gasification, durable, convenient to use and environment-friend, which has good and reliable performance and a function of illumination.

A multifunctional and portable solar charger according to the present invention, comprising: a cover body; a seat body connected to said cover body in a foldaway manner; solar silicon panels provided on inner surfaces of said cover body and said seat body, respectively; a storage battery provided in said seat body, wherein said solar silicon panels are connected to said storage battery.

The multifunctional and portable solar charger according to the present invention, wherein an illuminating lamp is provided at one end of a hinge connected between said cover body and said seat body, and a switch connected to said illuminating lamp is provided at one end of said seat body.

The multifunctional and portable solar charger according to the present invention, wherein on one end of said seat body are provided an AC charging jack, a power supply jack for mini-type electrical apparatus, a switch indicating lamp and charging state indicating lamps, respectively.

The multifunctional and portable solar charger according to the present invention, wherein a buckling member through which a strap could be passed is provided on said back of said seat body, which is convenient for the user to buckle the charger to the backpack or clothing. The multifunctional and portable solar charger according to the present invention has the following advantageous: it is convenient and practical to use the solar energy, the solar charger can be charged at any time as long as the sunlight is sufficient in spite of the place such as outdoors or suburb, thus achieving the conversion of the solar energy into the chemical energy and transform between the low voltage and the high voltage. When the electrical energy in the charger is sufficient, the solar charger can charge a mobile phone or a portable computer and be connected to a mini-type electrical apparatus, thus achieving the conversion of the chemical energy into the electrical energy and transform between the high voltage and the low voltage, so that the electrical energy is transferred to another electrical product. The solar charger can be used as an electric torch at night after it is charged in the daytime. The solar charger of the present invention is novel in the structure, economical in energy, and has a high reliability and a good applicability.

### BRIEF DESCRIPTION OF THE DRAWINGS

The multifunctional and portable solar charger according to the present invention will be described in detail with reference to the accompanying drawings, in which:

FIG. 1 is a structural schematic view of the portable solar charger according to the first embodiment of the present invention in an opened state;

FIG. 2 is a structural schematic view of the portable solar charger according to the first embodiment of the present invention in a folded state;

FIG. 3 is a structural schematic side view of the portable solar charger according to the first embodiment of the present invention in the folded state;

FIG. 4 is a bottom schematic view of the portable solar charger according to the first embodiment of the present invention;

FIG. 5 is an exploded structural view of the portable solar charger according to the first embodiment of the present invention;

FIG. 6 is an exploded structural view of the portable solar charger according to the second embodiment of the present invention;

FIG. 7 is a bottom schematic view of the portable solar charger according to the second embodiment of the present invention;

FIG. 8 is a block diagram showing the circuit principle of the portable solar charger of the present invention.

### DETAILED DESCRIPTIONS OF THE PREFERRED EMBODIMENTS OF THE INVENTION

### The First Embodiment

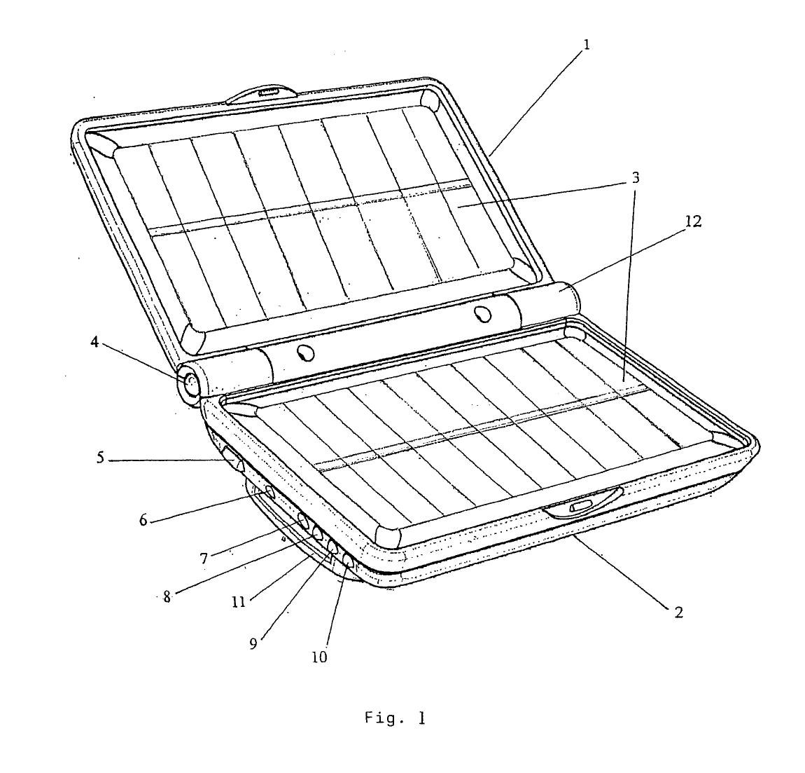

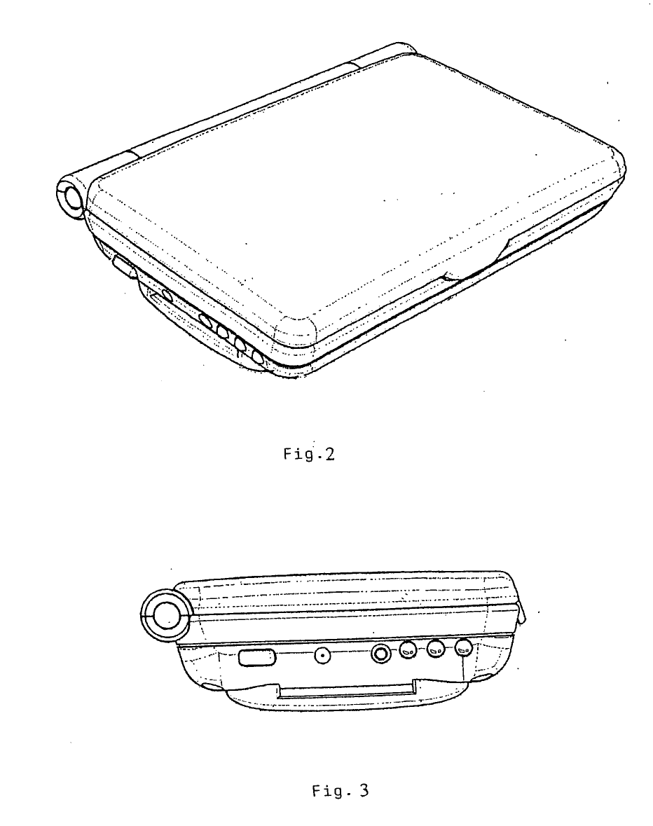

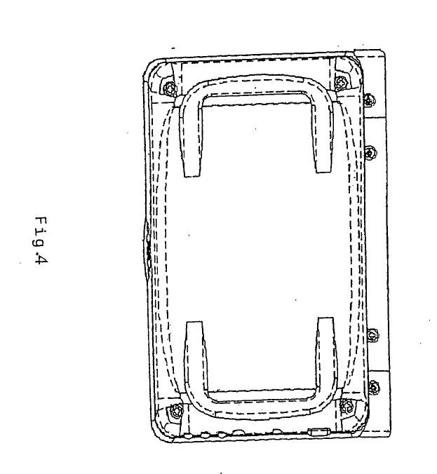

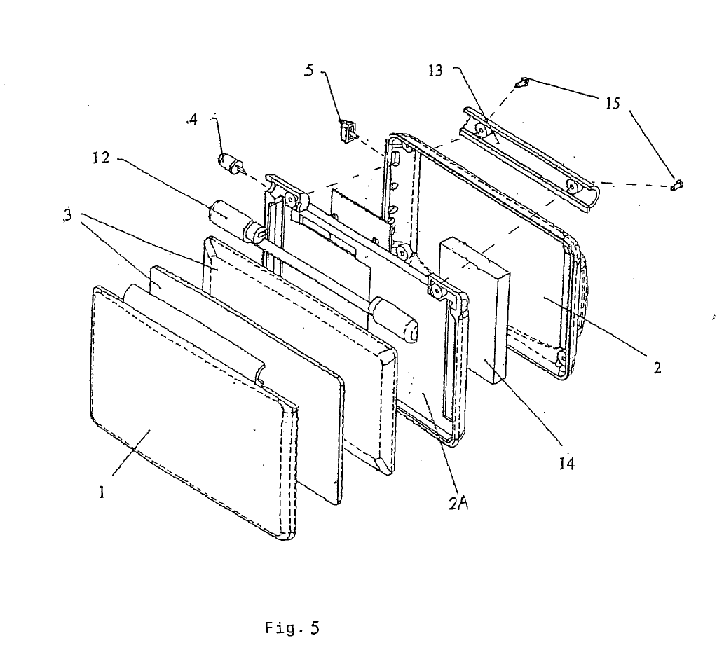

As shown in FIG. 1 to FIG. 5, a multifunctional and portable solar charge according to the first embodiment of the present invention comprises a cover body 1 and a seat body 2 which are connected to each other in a foldaway manner, solar silicon panels 3 are provided on inner surfaces of the cover body 1 and the seat body 2 respectively, a storage battery 14 is provided in the seat body 2, the solar silicon panels 3 are connected to the storage battery 14, the solar silicon panels 3 receive sunlight for converting light energy into electrical energy and charging the storage battery 14 with electrical energy, thus performing the conversion of the solar energy into the chemical energy and the transform of the low voltage into high voltage and the switching between the direct current (DC) input and the alternating current (AC) input. An illuminating lamp 4 is provided at one end of a hinge 12 connected between the cover body 1 and the seat body 2, and a switch 5 is provided at one end of the seat body 2 and connected to the illumination lamp 4, the hinge 12 is connected to the cover body 1 and the seat body 2 via a hinge cover 13 and screws 15. An AC charging jack 6 and a power supply jack 7 for mini-type electrical apparatus are provided on one end of the seat body 2, respectively. The AC charging jack 6 can switch between the input and output mode of the solar charger automatically, when it is connected to a mobile phone, the AC charging jack 6 can supply electrical power to the mobile phone, when it is connected to a transformer, the AC charging jack 6 could be used for storing electrical energy. In addition, there are also provided a on/off indicating lamp 8 and charging state indicating lamps 9 and 10. When the solar silicon panels 3 receive sunlight, the indicating lamp 9 shall flash, and the indicating lamp 10 will shine when the charging is performed and extinguished automatically when the storage battery is fully charged with electrical energy. A buckling member 11 through which a strap could be passed is provided on the back of the seat body 2. The solar charger of the present invention can convert the chemical energy into the electrical energy and transform the low voltage into high voltage.

The multifunctional and portable solar charger of the present invention is in an opened state during use, that is, the solar Si panels 3 face the sun so as to charge the storage battery 14. In addition, the solar charger of the present invention can be hung to a belt, a kitbag or other satchels and be charged at any time outdoors, so that the solar charger is portable and very convenient to use.

### The Second Embodiment

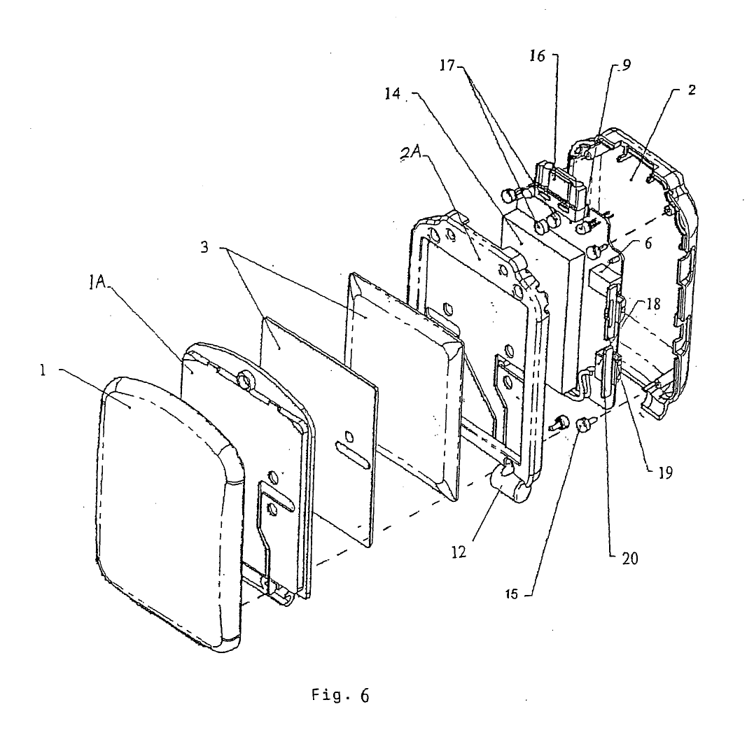

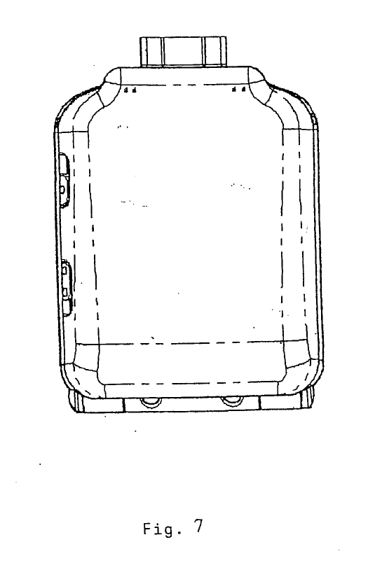

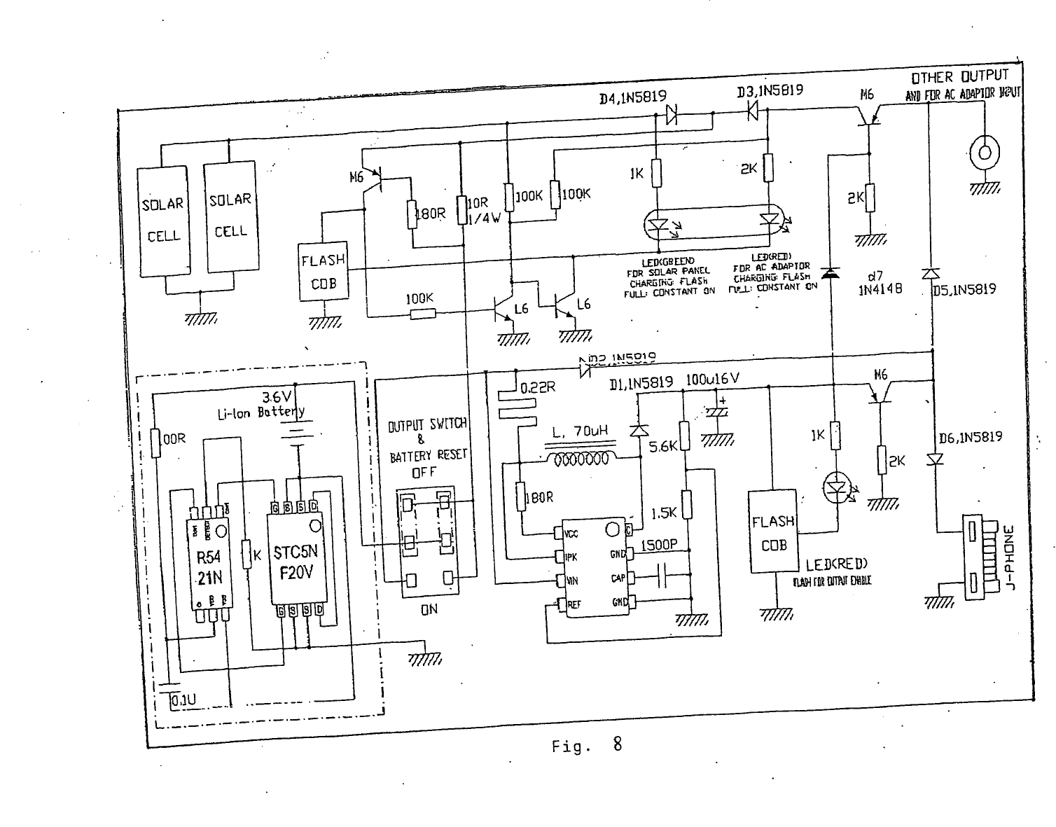

As shown in FIG. 1 and FIG. 6, a multifunctional and portable solar charge according to the second embodiment of the present invention comprises a cover body 1 and a seat body 2 which are connected to each other in a foldaway manner, solar silicon panels 3 are provided on inner surfaces of the cover body 1 and the seat body 2 respectively, a storage battery 14 is provided in the seat body 2. A socket 16 is provided on a bottom plate 2B connected to the storage battery 14, a power output of the charger of the present invention is connected to a mobile phone when it is used to charge the mobile phone. A hinge 12 is connected to the cover body 1 and the seat body 2 via a hinge cover 13 and screws 15. Indicating lamps 9 and 10 are provided on sides of the socket 16 and used for indicating whether the charger is in working state. An AC charging jack 6, a function selection button 18 and plastic sliding plates 19 and 20 are provided on a side of the seat body 2, the sliding plate 19 is used for opening or closing the AC charging jack 6, the sliding plate 20 is positioned on a side of the function selection button 18 for increasing the pushing stroke.

The multifunctional and portable solar charger of the present invention is in an opened state during use, that is, the solar Si panels 3 face the sun so as to charge the storage battery 14. The multifunctional and portable solar charger of the present invention is designed in a palmtop type so that it is convenient to carry and use.

1. A multifunctional and portable solar charger, comprising:
a cover body (1);
a seat body (2) connected to said cover body in a foldaway manner;
solar silicon panels (3) provided on inner surfaces of said cover body (1) and said seat body (2), respectively;
a storage battery (14) provided in said seat body (2),
said solar silicon panels (3) are connected to said storage battery (14).

2. The multifunctional and portable solar charger according to said claim 1, wherein an illuminating lamp (4) is provided at one end of a hinge (12) connected between said cover body (1) and said seat body (2), and a switch (5) connected to said illuminating lamp (4) is provided at one end of said seat body (2).

3. The multifunctional and portable solar charger according to said claim 1, wherein on one end of said seat body (2) are provided an AC charging jack (6), a power supply jack (7) for mini-type electrical apparatus, a on/off indicating lamp (8) and charging state indicating lamps (9) and (10), respectively.

4. The multifunctional and portable solar charger according to said claim 1, wherein a buckling member (11) through which a strap could be passed is provided on said back of said seat body (2).

5. The multifunctional and portable solar charger according to said claim 1, wherein said cover body (1), said seat body (2), said hinge (12), said solar Si panels (3), and said built-in storage battery (14) are connected to a AC charging socket (16), said AC charging socket (16) is provided on a front surface or a side surface of said seat body (2).

6. The multifunctional and portable solar charger according to said claim 1, wherein said solar energy is converted into chemical energy and stored in said storage battery, a voltage in said storage battery is boosted, and said electrical energy is transferred to another storage battery or a mini-type electrical apparatus such as a mobile phone based on a principle of water level difference.

7. The multifunctional and portable solar charger according to said claim 1, wherein said solar energy is converted into chemical energy and stored in said storage battery, and its AC power supply is designed in a common electrical circuit.
